(19) United States
(12) Patent Application Publication
(10) Pub. No.: US 2021/0237096 A1
(43) Pub. Date: Aug. 5, 2021

(54) SUSPENDABLE SELF-POWERED CHIPPING DEVICE

(71) Applicants: Anders RAGNARSSON, Chester, NH (US); Edvin LENNARTSSON, Skärblacka (SE); Gustaf THORMALM, Holsbybrunn (SE)

(72) Inventors: Anders RAGNARSSON, Chester, NH (US); Edvin LENNARTSSON, Skärblacka (SE); Gustaf THORMALM, Holsbybrunn (SE)

(21) Appl. No.: 16/782,672

(22) Filed: Feb. 5, 2020

(51) Int. Cl. B02C 18/14; B02C 18/24

(52) U.S. Cl. CPC B02C 18/14; B02C 18/24

(57) ABSTRACT

A chipping device that has a chipper framework and a rotor having a plurality of spaced apart replaceable knives, teeth or strikers mounted on a periphery of the rotor and which cooperate with at least one anvil for comminuting desired limbs, branches or trunks of trees into chips having a desired size. A combustion engine supplies rotational drive to at least the rotor. A hydraulic power source for supplying power to hydraulic components of the chipping device and controlling operation thereof. Both the engine and the hydraulic power source being solely and entirely supported by the chipper framework so as to move along with the suspendable chipping device.

### FIELD OF THE INVENTION

The present invention relates to a chipping device which is self-powered so that when the self-powered chipping device is suspended from a crane, or some other (hydraulically) actuated arm, the chipping device can be moved into engagement with one or more desired areas or sections of a tree so as to chip and remove the limbs and branches and/or the trunk of the trees without requiring any personnel to be located within the tree.

### BACKGROUND OF THE INVENTION

Chipping devices or rather wood chippers are machines that are commonly utilized in reducing and/or clearing and removing tree branches, limbs and trunks from an area of land. The chipping devices process the branches, limbs and trunks of trees reducing them into smaller wood chips. Some of the chipping devices on the market can be suspended by the boom or arm of a crane or some other similar heavy duty vehicle, for example. These known chipping devices are powered by the crane or heavy duty vehicle that they are attached to. One of the drawbacks of these known chipping devices is the limited reach of the boom or arm to which they are attached.

A further drawback of such known chipping devices is the limited power that can be practically conveyed out these devices which results in limiting the processing capacity these chipping devices.

It is also known to utilize aerial lifts, commonly referred to as bucket trucks, in reducing and/or clearing and removing tree branches, limbs and trunks. Such lifts have a bucket in which a person can stand and which can be elevated to a position where the operator can reach the portion of the tree to be cut. One of the drawbacks of these aerial lifts during tree removal is that it typically requires a person, who will be operating a chainsaw, to be lifted up to an elevated height at which the stability of the lift is reduced thereby creating a hazardous situation for the person. Such aerial lifts are also known as being expensive.

The use of these aerial lifts in tree removal also forces the cut branches, limbs or sections of tree to be dropped to the ground before being chipped into small pieces. This requires additional personnel on the ground to clean up and secure the working area.

Additionally, these aerial lifts/bucket trucks also have a limited reach and are less effective at clearing and removing branches, limbs and trunks of tall trees.

### SUMMARY OF THE INVENTION

Wherefore, it is an object of the present invention to overcome the above mentioned shortcomings and drawbacks associated with the prior art.

A further object of the present invention is to provide a chipping device with its own source of operating power so that all of the power requirements, for powering the associated components of the chipping device, are supplied directly by the power source that is incorporated and fully integrated into the chipping device. In other words, the chipping device, according to the present disclosure, is entirely self-powered and can operate without connecting to a source of power that is remote from the chipping device.

Another object of the present invention is to provide a chipping device that can be suspended from a crane and cable system so as to have a significantly greater reach then conventional booms or arms which enables the limbs or branches of desired sections or areas of trees to be quickly and efficiently removed without requiring any personnel to climb or be located at an elevated height in the tree or in a lift adjacent the tree during removal of the desired trees branches, limbs and/or trunk. Further, as the chipping device is suspended, via the cable, by a boom, an arm or a jib of a crane or some other similar heavy duty vehicle, for example, the only force applied on the boom by the chipping device is the downwardly directed force resulting from the weight of the chipping device. That is to say, all of the torques and forces resulting from the chipping device, except for the downwardly directed force, are disconnected from the boom, arm or jib of the crane or other similar heavy duty vehicle. Additionally, substantially any standard crane with a cable and hook can be utilized with the chipping device of the present disclosure.

Yet a further object of the present invention is to equip the chipping device with a radio control receiver which communicates wirelessly, via radio signals, with a radio control transmitter typically located within an operator's cabin at the base of the crane or some other piece of heavy duty vehicle supporting the self-powered chipping device. The operator is thus able to send desired commands, e.g., start the engine, rotate the rotor, etc., from the transmitter to the receiver in order to control remotely operation of the chipping device. In addition the chipping device can be hydraulically actuated, by remote control, so to rotate and steer the chipping device when it is utilized with a jib which forcefully controls rotation of the chipping device.

Another object of the present invention is to provide a chipping device with a rotor having a plurality of knives, teeth or strikers that cooperate with a primary or secondary anvil to comminute limbs, branches or trees into wood chips. The rotor and the primary and secondary anvils are arranged on the chipping device such that movement of the chipping device relative to the limbs, branches or trees in either a horizontal or vertical direction maximizes comminuting interaction of the knives, teeth or strikers with the limbs, branches or trees so as to maximize the efficiency of the chipping device.

A further object of the present invention is to provide the chipping device with a secondary anvil that can be pivoted to a comminuting position during downward movement of the chipping device relative to the limbs, branches or trees or can be pivoted to a neutral position during horizontal movement of the chipping device relative to the limbs, branches or trees so as to enhance comminuting interaction of the knives, teeth or strikers with the limbs, branches or trees based on the (horizontal or vertical) direction of movement of the chipping device toward the limbs, branches or trees.

A still further object of the present invention is to provide the chipping device with a camera, which communicates wirelessly with a display device, and facilitates viewing of the chipping device during operation thereof by an operator to assist With accurate manipulation of the chipping device by the operator.

Another object of the present invention is to provide a chipping device having primary and secondary anvils that are designed and/or positioned relative to the plurality of spaced apart replaceable knives, teeth or strikers mounted on the rotor such that self-feeding of the limbs, branches or trunks of trees into the chipping device during operation thereof is reduced, minimized or prevented. In other words, the anvils and strikers of the chipping device are designed and positioned such that the chipping device does not pull, draw or force the limbs, branches and/or trunks of trees into the chipping device once chipping thereof has started. This enables desired commination of the limbs, branches and/or trunks of trees to occur only as the chipping device is moved in a direction toward the limbs, branches and/or trunks of trees.

Yet another object of the present invention is to provide the chipping device with chip storage box which collects and stores the wood chips that are produced as the desired limbs, branches or trunks of trees are comminuted by the chipping device. The chip storage box has a door which can be hydraulically opened and closed such that the accumulated chips can be emptied from the chip storage box in a controlled manner, for example into the bed of a dump truck if removal of the chips from the work site is desired.

A still further object of the present invention is to provide a suspendable chipping device that has a chipper framework and a rotor having a plurality of spaced apart replaceable knives, teeth or strikers located on a periphery of the rotor which cooperate with at least one anvil for comminuting desired limbs, branches or trunks of trees into chips having a desired chip size. An engine supplies rotational drive to the at least the rotor, A hydraulic power source supplies power to hydraulic components of the chipping device so as to control operation of the hydraulic components. Both the engine and the hydraulic power source are solely and entirely supported by the chipper framework so as to move along with the suspendable chipping device.

### BRIEF DESCRIPTION OF THE DRAWINGS

The accompanying drawings, which are incorporated in and constitute a part of the specification, illustrate various embodiments of the invention and together with the general description of the invention given above and the detailed description of the drawings given below, serve to explain the principles of the invention. The invention will now be described, by way of example, with reference to the accompanying drawings in which:

FIG. 1 is a diagrammatic perspective view from the front, bottom, left side of a chipping device according to the disclosure showing a secondary anvil in a lifted neutral position;

FIG. 2 is diagrammatic partial cross sectional view from the front, top, left side of the chipping device according to FIG. 1 showing the secondary anvil in the lifted neutral position;

FIG. 3 is diagrammatic perspective view from the rear, left, bottom side of the chipping device according to FIG. 1 with the secondary anvil in the lifted neutral position;

FIG. 4 is diagrammatic partial cross sectional view from rear, left, bottom side cross-sectional view showing the chipping device according to FIG. 1 with the secondary anvil in the lifted neutral position;

FIG. 5 is a diagrammatic left side partial cross-sectional view of the chipping device according to FIG. 1 with the secondary anvil in the lifted neutral position;

FIG. 6 is a diagrammatic left side partial cross sectional view cross-sectional view of the chipping device according to FIG. 1 with the secondary anvil in a lowered comminuting position; and

FIG. 7 is a diagrammatic front, left, top side partial cross sectional view cross-sectional view of the chipping device according to FIG. 1 with the secondary anvil in the lowered comminuting position.

It should be understood that the drawings are not necessarily to scale and that the disclosed embodiments are sometimes illustrated diagrammatical and in partial views. In certain instances, details which are not necessary for an understanding of this disclosure or which render other details difficult to perceive may have been omitted. It should be understood, of course, that this disclosure is not limited to the particular embodiments illustrated herein.

### DETAILED DESCRIPTION OF THE PREFERRED EMBODIMENTS

The present invention will be understood by reference to the following detailed description of the disclosure, which should be read in conjunction with the appended drawings. It is to be appreciated that the following detailed description of various embodiments is by way of example only and is not meant to limit, in any way, the scope of the present invention.

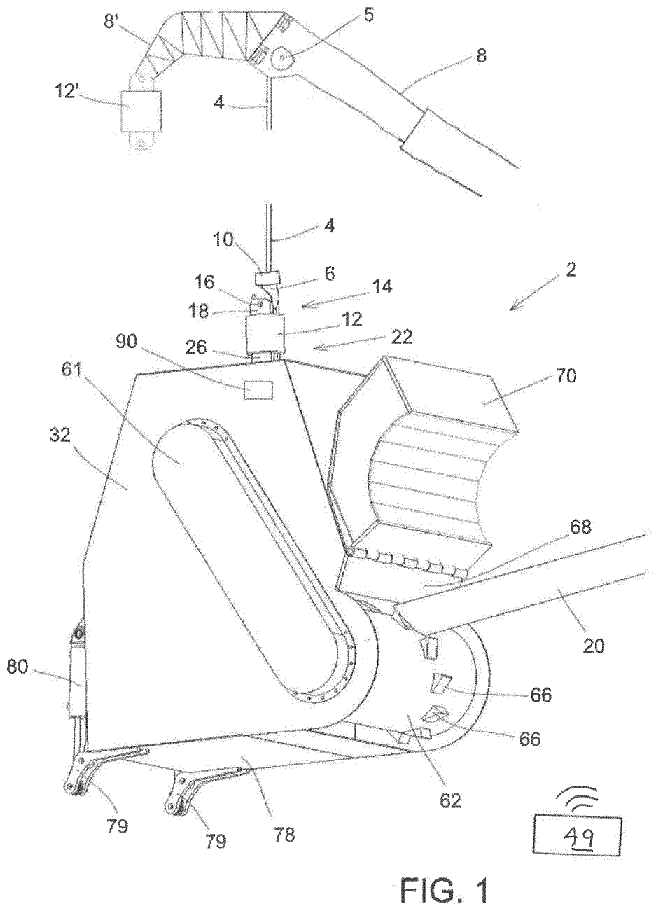

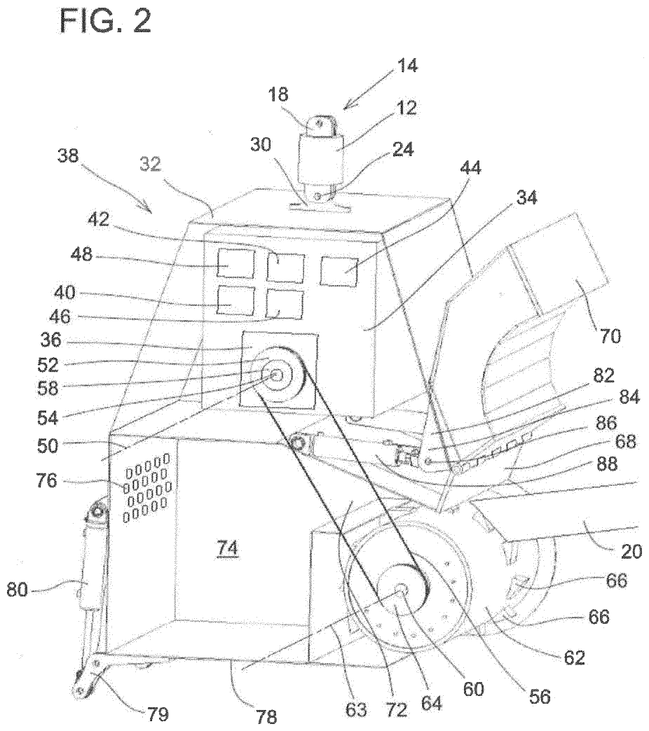

Turning now to the figures, a brief description concerning the various components of the suspendable self-powered chipping device will now be briefly discussed. As can be seen in FIGS. 1 and 2, the present invention relates to a chipping device 2 which can be suspended, via a cable 4 or support line and a hook 6, from a hydraulically actuated arm, boom or jib 8 of a conventional crane, a heavy equipment base, motorized forestry equipment, or some other similar heavy duty vehicle. The cable 4 can be coupled to the arm, boom or jib 8 at a pivot point 5, e.g., a pulley, such that the chipping device 2 can swing laterally like a pendulum. In this manner, only vertical forces are applied to the arm, boom or jib 8 during operation of the chipping device 2. As is typical in the art, a rotatable swivel 10 is installed between the end of the cable 4 and the hook 6 so as to permit the hook 6 to rotate or turn relative to the cable 4 during operation.

It is to be appreciated that a non-electrically conductive sling can utilized between the chipping device 2 and hydraulically actuated arm, boom or jib 8 such that if, for some unintended reason, the chipping device 2 inadvertently contacts or touches a power line during operation, the non-electrically conductive sling will prevent any electricity from flowing along the chipping device 2 through the non-electrically conductive sling and along the cable 4 to the hydraulically actuated arm, boom or jib 8 and thereby avoid possible electrocution of the operator of the chipping device 2.

As generally shown, the chipping device comprises a hydraulic rotator 12 which facilitates coupling of the chipping device 2 to the conventional hook 6 of the hydraulically actuated arm, boom or jib 8, for example, or some other suspension mechanism and helps to steer the chipping device 2. The hydraulic rotator 12 comprises an upper section 14 which comprises a first pin 16 which extends between a pair of side walls or plates 18 of the upper section 14 of the hydraulic rotator 12. The hook 6 of the hydraulically actuated arm, boom or jib 8 engages with the first pin 16 in order to suspend the chipping device 2 (as discussed below in further detail) and thus assist with controlling vertical and (sideways) horizontal movement of the chipping device 2 relative to the ground as well as the limbs, branches and/or trunk 20, 21 of a tree to be chipped.

A lower section 22 of the hydraulic rotator 12 has a second pin 24 which extends between a pair of side walls or plates 26 of the lower section 22 of the hydraulic rotator 12. The lower section 22 of the hydraulic rotator 12 is connected to receive a supply of hydraulic fluid from a hydraulic power source (discussed below in further detail). When a first supply of hydraulic fluid is supplied to the lower section 22 of the hydraulic rotator 12, the lower section 22 of the hydraulic rotator 12 rotates or turns in a first rotational direction relative to the upper section 14 of the hydraulic rotator 12. When a second supply of hydraulic fluid is supplied to the lower section 22 of the hydraulic rotator 12, the lower section 22 of the hydraulic rotator 12 rotates or turns in an opposite second rotational direction relative to the upper section 14 of the hydraulic rotator 12. Such rotation of the lower section 22 of the hydraulic rotator 12 relative to the upper section 14 of the hydraulic rotator 12 permits the operator to suggest or induce desired rotation of the chipping device 2 to achieve a desired position or orientation of the chipping device 2 relative to the limbs, branches, and/or trunk 20, 21 of the tree to be chipped.

An upper most portion of the chipping device 2 has a centrally located bracket 30 with a mounting hole and the second pin 24 of the lower section 22 of the hydraulic rotator 12 passes through the mounting hole of the centrally located bracket 30 to suspend the chipping device 2 from the hydraulic rotator 12. The second pin 24 is secured to the lower section 22 of the hydraulic rotator 12, in a conventional manner, so as to prevent inadvertent removal of the second pin 24 during operation of the chipping device 2. The second pin 24 generally defines a device pivot axis about which the chipping device 2 can pivot or rock back and forth, during operation of the chipping device 2.

All of the components of the chipping device 2 are supported by a main body that is sufficiently thick, robust and durable so as to form a rugged framework 32 which is suitable to accomplish the chipping operation described herein.

The chipping device 2 is equipped with its own completely self-contained power assembly 34 which functions to provide, control and direct all the power and drive necessary for operating the self-powered chipping device 2. The power assembly 34 includes a combustion (e.g., gas or diesel) engine 36, e.g., a 50-400 hp engine for example, which can be mounted to the framework 32 in an enclosed upper compartment 38 of the chipping device 2. In addition, the power assembly 34 includes a source of hydraulic power such as a hydraulic pump 40 which generates a supply of hydraulic fluid for operation of the hydraulic components of the chipping device 2. The hydraulic pump 40 can be connected to and driven by the combustion engine 36 or, alternatively, can be driven by an electric motor which is powered by a battery source.

The power assembly 34 further includes a hydraulic oil reservoir 42 that is associated with the hydraulic pump 40, at least one directional valve 44 for controlling the flow of the hydraulic fluid from the hydraulic pump 40 to the various hydraulic components of the chipping device 2, a fuel/power supply 46, e.g., a (gas or diesel) fuel tank for powering the combustion engine 36 and possibly a battery or batteries for powering the electric motor and a control unit 48 which receives control signals from the operator for controlling operation of the chipping device 2. All of these components of the power assembly 30 (power assembly components), for example the combustion engine 36, the hydraulic pump 40 and oil reservoir 42, the directional valve 44, the fuel/power supply 46, and control unit 48 etc., are only diagrammatically shown in FIG. 2 and are mounted or supported in/on the rugged framework 32 of the chipping device 2. With the power assembly 34 being directly supported by the framework 32, the chipping device 2 is to be considered as being “self-powered.” That is to say, in other words, that no external power or drive is transferred from the hydraulically actuated arm, boom or jib 8 of the crane or some other similar heavy duty vehicle to the chipping device 2 to facilitate operation thereof. Accordingly, the chipping device 2 does not require any power lines, hydraulic lines, electrical cables or the like to be connected between the chipping device 2 and the crane or other similar heavy duty vehicle maneuvering the chipping device 2.

As shown in the drawings, the power assembly 34 is supported in the upper compartment 38 of the framework 32 such that the combustion engine 36 has a rotational axis 50 which normally extends parallel to the ground. A conventional pulley 52 is supported at a free end of an output shaft 54 of the combustion engine 36 and the pulley 52 engages with a conventional belt 56. A conventional clutch 58 is located between and interconnects the output shaft 54 of the combustion engine 36 with the pulley 52 supported on the output shaft 54. An input shaft 60 of a rotor 62 has a mating pulley 64 support adjacent one end thereof and this pulley 64 is driven by the belt 56 so as to transmit rotational drive from the combustion engine 36 to the rotor 62. The pulleys 58, 64 and the belt 56 can be enclosed in a guard or housing 61 (see FIG. 1) which is fixed to the outside of the framework 32. As diagrammatically shown, the rotational axis 50 of the combustion engine 36 is parallel to a rotational axis 63 of the rotor 62. A plurality of spaced apart replaceable knives, teeth or strikers 66 are secured about a periphery of the rotor 62 and the knives, teeth or strikers 66 cooperate with either a primary or a secondary anvil 68, 70 (discussed below in further detail) to comminute limbs, branches and/or trunks 20, 21 of trees into wood chips having a desired chip size.

The rotor 62 has a diameter between 18-30 inches or so, for example, and has a width of between 2 feet and 4 feet, for example. The rotor 62 can be driven at a rotational speed of between 600 and 3,500 RPM, for example. It is to be appreciated that the overall diameter, length and rotational speed of the rotor 62 can vary from application to application, without departing from the spirit and scope of the present disclosure.

As is conventional in the art, the knives, teeth or strikers 66 of the rotor 62 are designed such that during rotation of the rotor 62, the knives, teeth or strikers 66 break or fragment the desired limbs, branches and/or trunk 20, 21 of the tree to be chipped into relatively small wood and debris chips and force the same either against the secondary anvil 70 or the primary anvil 68, depending upon the position of the secondary anvil 70. The chips are then conveyed, due to the rotational motion of the rotor 62, from either the secondary or the primary anvil 70, 68 and then along an upwardly inclined chute 72 into an upper section of a chip storage box 74, from which location the chips can fall, due to gravity, toward a bottom section of the storage box 74 where they gradually collect and accumulate.

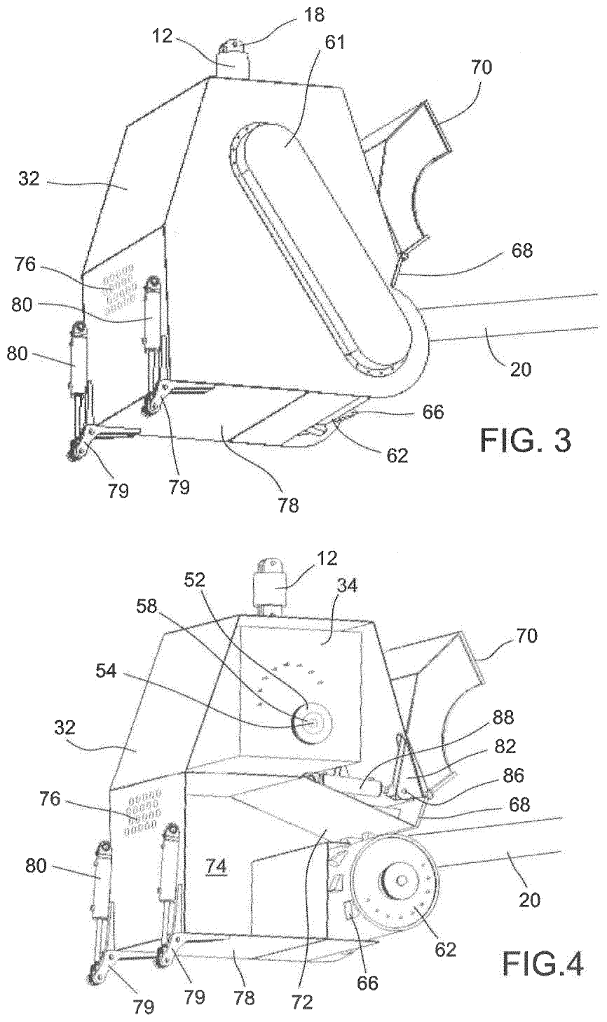

The chip storage box 74 is provided with a plurality of vent holes 76 (see FIGS. 2, 3, 4) which permit the air, conveying the chips into the chip storage box 74, to escape therefrom while still retaining the chips within the chip storage box 74. A suitable screen, having a desired mesh size, may cover these vent holes 76 so as to permit the air to pass readily therethrough while preventing any of the chip from exiting the chip storage box 74.

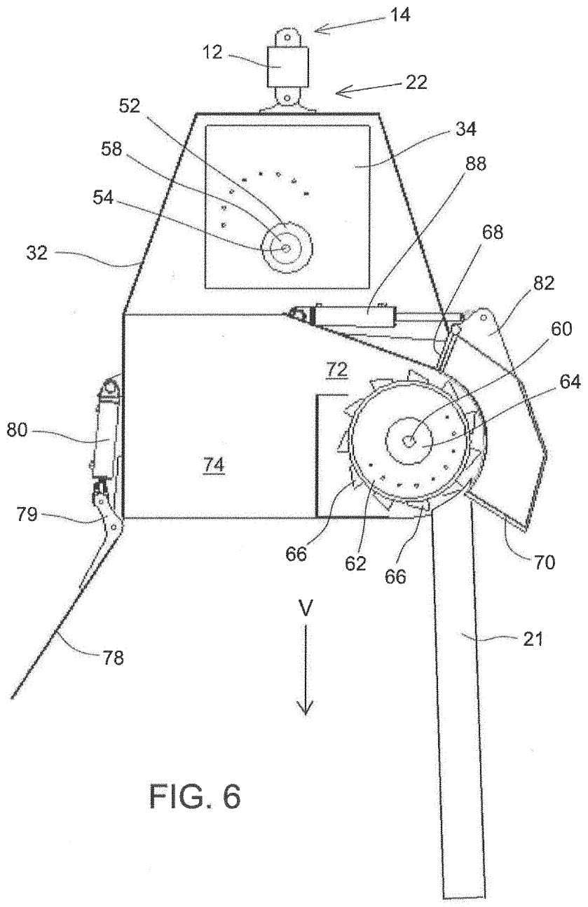

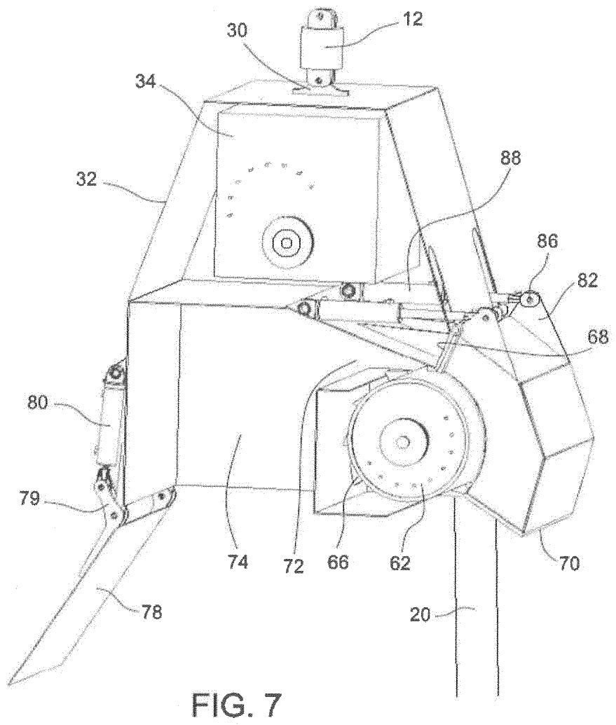

To facilitate emptying of the chip storage box 74, the chip storage box 74 is provided with a movable bottom door 78 which is connected to the framework 32 by pivotable brackets 79 along one side of the chip storage box 74. Operation of the bottom door 78 is controlled by a hydraulically operated door cylinders 80 that has one end secured to the framework 32 and the opposite end secured to a remote end of the brackets 79. The hydraulically operated door cylinders 80 are normally supplied with hydraulic fluid so that the hydraulically operated door cylinders 80 are in their fully extended position so that the bottom door 78 is biased by the hydraulically operated door cylinders 80 into its closed position (as shown in FIGS. 1-5) to close the chip storage box 74 and assist with collection and accumulation of chips therein. However, when hydraulic fluid is supplied to the opposite side of the hydraulically operated door cylinders 80, the hydraulically operated door cylinders 80 will move into their retracted position and thereby pivoting and moving the bottom door 78 into its open position (as shown in FIGS. 6 and 7) which permits discharge, due to gravity, of all of the chips contained therein. Once all of the chips are discharged from the chip storage box 74, then the hydraulically operated door cylinders 80 are supplied hydraulic fluid so that the hydraulically operated door cylinders 80 return back into their extended position which biases the bottom door 78 back into its normally closed position which closes the chip storage box 74. The closed bottom door 78 can thereafter again assists with collection and accumulation of chips in the chip storage box 74.

Although the figures show the chipper device 2 as having a pair of hydraulically operated door cylinders 80, it is to be appreciated that the bottom door 78 can be moved between its open and closed positions by a single hydraulically operated door cylinder 80. Alternatively, the arrangement of the brackets 79 and the hydraulically operated door cylinder 80 can be reversed so that when the hydraulically operated door cylinders 80 are normally supplied with hydraulic fluid, the hydraulically operated door cylinders 80 are in their retracted position and the bottom door 78 is biased by the hydraulically operated door cylinders 80 into its closed position. When an opposite end of the hydraulically operated door cylinders 80 is supplied with hydraulic fluid, the hydraulically operated door cylinders 80 move into their extended position and the bottom door 78 is biased by the hydraulically operated door cylinders 80 into its open position.

As noted above, the chipping device 2 is equipped with both the primary anvil 68 and the secondary anvil 70. The secondary anvil 70 is supported by a pivotable arm 82 that has a remote end 82 hingedly connected to the chipper framework 32 by a pin 86, and this pin 86 defines a pivot axis for the pivotable arm 82. A (arm) hydraulic cylinder 88 is connected to the pivotable arm 82 to control operation thereof. The (arm) hydraulic cylinder 88 is normally supplied with hydraulic fluid so that the (arm) hydraulic cylinder 88 is in its extended position in which the secondary anvil 70, supported by the pivotable arm 82, is located in its operative comminuting position for interaction with the rotating rotor 62, as shown in FIGS. 6 and 7. When hydraulic fluid is supplied to the opposite side of the (arm) hydraulic cylinder 88, the (arm) hydraulic cylinder 88 will move into its retracted position and thereby pivot and move the pivotable arm 82 so as to lift the associated secondary anvil 70 to a lifted neutral position, as shown in FIGS. 1-5, away from the rotor 62 so that the secondary anvil 70 no longer cooperates with the rotor 62 to comminute the tree to be chipped. As a result of such pivoting movement of the pivot arm, the secondary anvil 70 is lifted and spaced away from the rotor 62 such that the rotor 62 can now cooperate with the primary anvil 68, during operation of the chipping device 2, to comminute limbs and branches 20 which are to be chipped by the chipping device 2.

In the event that the operator desires to chip the trunk 21 of a tree, for example, then the (arm) hydraulic cylinder 88 is supplied hydraulic fluid so that the (arm) hydraulic cylinder 88 moves back into its extended position which, in turn, biases the pivotable arm 82, as well as the supported secondary anvil 70, back into its operative comminuting position (see FIGS. 6 and 7) closely adjacent the rotor 62 so that the comminution of the tree will occur between the rotor 62 and the secondary anvil 70, instead of between the rotor 62 and the primary anvil 68.

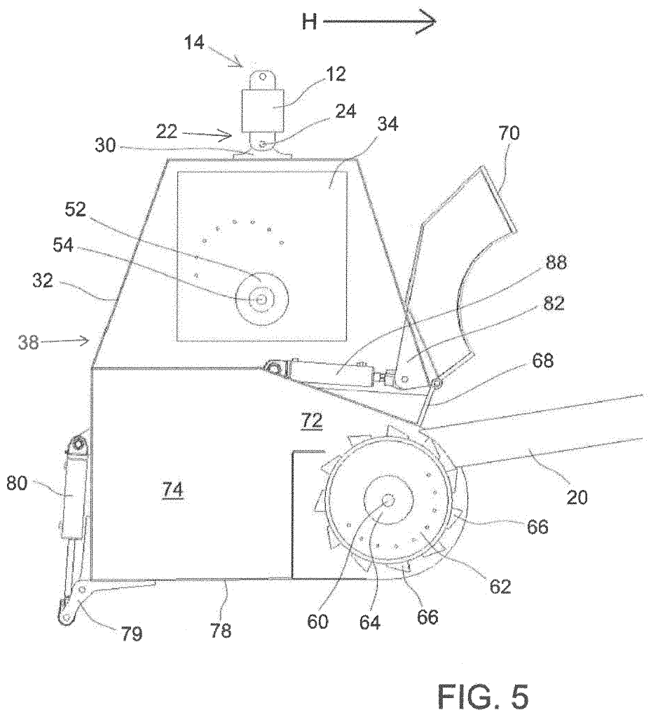

The chipper device 2 is designed such that the primary and secondary anvils 68, 70 are positioned about the circumferential periphery of the rotor 62 so that communication of the limbs, branches and/or trunks 20, 21 of the trees with the primary and secondary anvils 68, 70 and the rotating knives, teeth or strikers 66 does not normally pull, draw or force the limbs, branches and/or trunks 20, 21 into the chipper device 2. As the secondary anvil 70 is pivotable between its neutral and comminuting positions as described above, the knives, teeth or strikers 66 and the limbs, branches and/or trunks 20, 21 of the trees can interact with the anvils 68, 70 at two different locations about the circumference of the rotor 62. For example, when the secondary anvil 70 is in the operational comminuting position, the point of interaction between the anvil 70 (secondary anvil 70 in this case), the knives, teeth or strikers 66 and the limbs, branches and/or trunks 20, 21 is on the lower portion of the circumference of the rotor 62 (see FIG. 6). When, on the other hand, the secondary anvil 70 is in the lifted neutral position, the point of interaction between the anvil 68 (primary anvil 68 in this case), the knives, teeth or strikers 66 and the limbs, branches and/or trunks 20, 21 is on the upper portion of the circumference of the rotor 62 (see FIG. 5).

Due to the two different locations of the anvils 68, 70 or rather points of interaction, comminuting of the limbs, branches and/or trunks 20, 21 of the trees can be more efficient based on the direction of movement of the chipping device 2 relative to the limbs, branches and/or trunks 20, 21 of the trees and based on the general orientation of the limbs, branches and/or trunks 20, 21 of the trees relative to the ground. It is generally recognized that the trunks 21 of trees are usually oriented in a more or less vertical direction relative to the ground while limbs and/or branches 20 of trees usually extend outwardly from the trunks 21 of trees in a direction that is more or less horizontal relative to the ground. As such, chipping or comminuting of the generally horizontal limbs and/or branches 20 of trees by the chipping device 2 is most effect when the secondary anvil 70 is lifted to its neutral position and the chipping device 2 is moved sideways towards the limbs and/or branches 20 in a generally horizontal direction as shown by arrow H in FIG. 5. On the other hand, chipping or comminuting of the generally vertical trunks 21 of trees by the chipping device 2 is most effect when the secondary anvil 70 is lowered to its operational comminuting position and the chipping device 2 is moved downward towards the trunk 21 in a generally vertical direction as shown by arrow V in FIG. 6.

Additionally, because of the two different locations of the anvils 68, 70 or rather points of interaction and the general orientation of the limbs, branches and/or trunks 20, 21 of the trees, the typical “self-feeding” characteristics of the chipping device 2 are reduced, minimized or prevented. Chipping or mulching devices known in the art are designed to be “self-feeding.” In other words, when a limb, branch and/or trunk of a tree is initially fed into the known chipping/mulching devices, the known chipping/mulching devices are designed to engage the limb, branch and/or trunk and then continually drawing, puffing or forcing the limb, branch and/or trunk into the chipping/mulching device until the entire limb, branch and/or trunk is fully chipped or comminuted. In contrast, the chipping device 2 according to the invention is only designed to chip and comminute the limbs, branches and/or trunks 20, 21 once the knives, teeth or strikers 66 and anvils 68, 70 are engaged with the limbs, branches and/or trunks 20, 21 of the trees and as the operator continues to move the chipping device 2, via control of the arm, boom or jib 8, in the general direction toward the limbs, branches and/or trunks 20, 21 to be removed. In other words the anvils 68, 70 and knives, teeth or strikers 66 of the chipping device 2 are designed and positioned such that the chipping device 2 does not automatically pull, draw or force the limbs, branches and/or trunks 20, 21 of trees into the chipping device 2 once chipping thereof has commenced.

According to one variation, the chipper framework 32 of the chipping device 2 may supports a camera 90, which is only diagrammatically shown in FIG. 1, to facilitate remote viewing of the chipping device 2 by an operator to assist with precise movement and manipulation of the chipping device 2 relative to desired limbs, branches and/or trunk 20, 21 of a tree to be comminuted. The camera 90 is typically supported by a conventional bracket on an uppermost section of the chipper framework 32 and faces in the direction of the rotor 62. A mating display device is located within the crane or other piece of equipment to receive at least a wireless video signal from the camera 90 and facilitate viewing of the chipping device 2 by the operator. The camera 90 and the display device communicate wirelessly with one another, as is well known in the art.

The chipping device 2 includes a radio control receiver which can be connected to the control unit 48 of the power assembly 34 and which communicates wirelessly, via radio signals, with a radio control transmitter 49 typically located within an operator cabin at the base of the crane or other similar heavy duty vehicle. By this arrangement, the operator is able to send desired commands, e.g., start the engine 36 and rotate the rotor 62, actuate the (arm) hydraulic cylinder 88 to move the pivotable arm 82 of the secondary anvil 70, actuate the hydraulically operated door cylinders 80 to open/close the bottom door 78, etc., from the transmitter to the receiver in order to remotely control the entire operation of the chipping device 2.

As an alternative arrangement, diagrammatically shown in FIG. 1, a jib 8′ may be attached to the upper end of the arm or boom 8 of the crane or other similar heavy duty vehicle, for example, to provide additional reach over a desired structure, a power line, etc. The free end of the jib 8′ supports the rotator 12′ and the chipping device 2 is directly connected to the bottom portion of the rotator 12′. With the chipping device 2 directly connected to the jib 8′, via the rotator 12′, the jib 8′ is readily able to control the precise orientation of the chipping device 2 relative to a limbs, branches and/or trunk 20, 21 of the tree to be chipped. As such jibs 8′ are conventional and well known in the art, a further detail discussion concerning the same is not provided.

Operation of the Chipping Device

Assuming that the chipping device 2 is already suspended from a cable 4 of a crane or other heavy duty vehicle, when horizontal chipping of desired branches and/or limbs 20 of a tree is required, the operator remotely activates the combustion engine 36 of the power assembly 34 so as to begin rotation of rotor 62 such that the plurality of spaced apart replaceable knives, teeth or strikers 66 can commence comminuting the desired limbs and/or branches 20 into wood chips having a desired chip size. Before such horizontal comminuting can occur, hydraulic fluid is supplied to the (arm) hydraulic cylinder 88 to move the same into its retracted position and thereby pivot and move the pivotable arm 82 thereby pivoting and lifting the associated secondary anvil 70 to its lifted neutral position away from the rotor 62 (see FIGS. 1-5). As a result of such pivoting and lifting movement of the secondary anvil 70 away from the rotor 62, the primary anvil 68 is now exposed and can cooperate with the rotor 62, during operation of the chipping device 2, to comminute limbs and/or branches 20 which are to be chipped by the chipping device 2.

Next, the chipping device 2 is manipulated by the operator to move the rotor 62 of the chipping device 2 horizontally toward and into engagement with the desired limbs and/or branches 20 of the tree to be comminuted. As rotating knives, teeth or strikers 66 of the rotor 62 engage with desired limbs and/or branches 20 of the tree, the rotating knives, teeth or strikers 66 cooperate with the primary anvil 68 to break and/or fragment the desired limbs and/or branches 20 of the tree into relatively small pieces of wood. The reduced chips or pieces are then conveyed, due to the rotation of the rotor 62, along the upwardly inclined chute 72 into an upper section of the chip storage box 74 where, the chips can fail, due to gravity, toward a bottom section thereof and gradually collect and accumulate. As the desired limbs and/or branches 20 of the tree are comminuted by the chipping device 2, the operator constantly is moving or repositioning the rotor 62 of the chipping device 2 horizontally into engagement with a remainder of the desired limbs and/or branches 20 of the tree to be comminuted.

Once the desired limbs and/or branches 20 of the tree have been sufficiently comminuted so as to provide access to the trunk 21 of the tree, then the chipping operation is temporarily interrupted. The operator can then reposition the chipping device 2 to comminute additional limbs and/or branches 20 of the tree to be comminuted and then repeat the above process.

In the event that vertical chipping with the chipping device 2 is desired, then the combustion engine 36 commences rotation of the rotor 62 so that the plurality of spaced apart replaceable knives, teeth or strikers 66 can commence comminuting the desired trunks into wood chips having a desired size. In the event that the pivotable arm 82 and the associated secondary anvil 70 are in its lifted neutral position, spaced away from the rotor 62, then hydraulic fluid is supplied to the (arm) hydraulic cylinder 88 to move and pivot the same into its extended position so that the secondary anvil 70 is pivoted back to its operative comminuting position (see FIGS. 6 and 7) for cooperation with the rotor 62, during operation of the chipping device 2, as the chipping device 2 is moved vertically downward so as to comminute the trunk 21 of the tree to be chipped by the chipping device 2. As such vertical chipping occurs, the operator constantly is lowering and/or repositioning the chipping device 2 and, therefore the rotor 62, into engagement with a new section of the trunk 21 of the tree to be comminuted.

The operator can utilize the camera 90 (if present) to assist with operation of the arm or boom 8 of the crane or other heavy duty vehicle and manipulate and guide the chipping device 2 into engagement with the desired limbs, branches and/or trunk 20, 21 to be comminuted. It is to be noted that the operator may also rotate the lower section of the hydraulic rotator 12, relative to the hook 6, in order to induce desired alignment of the chipping device 2 with the desired limbs, branches and/or trunk 20, 21 to be comminuted.

After the chip storage box 74 becomes sufficiently filled with chips, then the chipping device 2 can be lowered toward the ground, or some other collection location or device, and the collected and accumulated chips can then be discharged from the chip storage box 74 of the chipping device 2 to empty the chip storage box 74. Thereafter, the chipping device 2 can be repositioned for additional comminuting procedures. During vertical chipping, the bottom door 78 may be moved into is open position so that as the operator lowers and/or repositions the chipping device 2 and, therefore the rotor 62, into engagement with a new section of the trunk 21 of the tree to be comminuted, the generated chips are directly conveyed toward the ground for collection. This arrangement thereby avoids the need to periodically empty the chip storage box 74 during operation.

While various embodiments of the present invention have been described in detail, it is apparent that various modifications and alterations of those embodiments will occur to and be readily apparent to those skilled in the art. However, it is to be expressly understood that such modifications and alterations are within the scope and spirit of the present invention, as set forth in the appended claims. Further, the invention(s) described herein is capable of other embodiments and of being practiced or of being carried out in various other related ways. In addition, it is to be understood that the phraseology and terminology used herein is for the purpose of description and should not be regarded as limiting. The use of “including,” “comprising,” or “having,” and variations thereof herein, is meant to encompass the items listed thereafter and equivalents thereof as well as additional items while only the terms “consisting of” and “consisting only of” are to be construed in a limitative sense.

The foregoing description of the embodiments of the present disclosure has been presented for the purposes of illustration and description. It is not intended to be exhaustive or to limit the present disclosure to the precise form disclosed. Many modifications and variations are possible in light of this disclosure. It is intended that the scope of the present disclosure be limited not by this detailed description, but rather by the claims appended hereto.

A number of implementations have been described. Nevertheless, it will be understood that various modifications may be made without departing from the scope of the disclosure. Although operations are depicted in the drawings in a particular order, this should not be understood as requiring that such operations be performed in the particular order shown or in sequential order, or that all illustrated operations be performed, to achieve desirable results.

Wherefore, we claim:

1. A suspendable chipping device comprising:
a chipper framework;
a rotor having a plurality of spaced apart replaceable knives, teeth or strikers on a periphery thereof which cooperate with at least one anvil for comminuting desired limbs, branches or trunks of trees into chips having a desired size;
a combustion engine for supplying rotation drive to at least the rotor;
a hydraulic power source for supplying hydraulic power to hydraulic components of the chipping device and controlling operation thereof; and
both the engine and the hydraulic power source being solely and entirely supported by the chipper framework so as to move along with the suspendable chipping device.

2. The chipping device according to claim 1, wherein the chipping device is coupled to a support line which hangs vertically from an arm of a crane, the support line is coupled to the support arm via a pivot point such that the chipping device swings laterally, and the chipping device is pivotably coupled to the support line such that the chipping device is rotatable about an axis defined by the support line.

3. The chipping device according to claim 1, wherein the hydraulic power source is a hydraulic pump that is driven by either the combustion engine or an electric motor for supplying the hydraulic power to the hydraulic components of the chipping device and controlling operation thereof.

4. The chipping device according to claim 3, wherein the chipper framework supports an oil reservoir connected to the hydraulic pump, a directional valve which directs the hydraulic power to the hydraulic components, a fuel supply, and a control unit which facilitates controlling operation of the chipping device.

5. The chipping device according to claim 4, wherein control unit comprises a radio, signal receiving unit which receives remotely transmitted radio control signals, from a transmitter, for controlling operation of the chipping device.

6. The chipping device according to claim 1, wherein the at least one anvil is supported on the chipper framework in an anvil position about the periphery of the rotor such that the cooperation between the knives, the teeth or the strikers and the at least one anvil only comminute the limbs, the branches or the trunks of the trees into chips after the knives, the teeth or the strikers engage the limbs, the branches or the trunks of the trees and the chipping device moves in a direction towards the limbs, the branches or the trunks of the trees.

7. The chipping device according to claim 1, wherein the chipper framework includes a chip storage box which collects and stores the chips as the limbs, the branches or the trunks of the trees are comminuted by the knives, the teeth or the strikers cooperating with the at least one anvil.

8. The chipping device according to claim 7, wherein the chip storage box has a movable door, when the door is in a closed position, the movable door facilitates collection and storage of the chips within the chip storage box, and when the movable door is in an open position, the movable door facilitates discharge of the chips from the chip storage box.

9. The chipping device according to claim 8, wherein an opening is provided in a bottom of the chip storage box and the movable cooperates with the opening to selectively open and close the opening.

10. The chipping device according to claim 7, wherein the chip storage box comprises a plurality of vent holes which permit aft, which conveys the chips into the chip storage box, to escape while retaining the chips within chip storage box.

11. The chipping device according to claim 1, wherein the rotor is an open chip rotor that is open on a lower side of the chipper framework to facilitate comminuting a tree trunk as the chipping device is lowered by a crane in a vertical direction down onto the tree trunk and comminuting tree branches as the chipping device is moved by the crane in a horizontal direction towards the tree branches.

12. The chipping device according to claim 1, wherein a camera is mounted on the chipper framework to provide an operator with a view of the chipping device and assist an operator with controlling operation of the chipper device in relation to the limbs, the branches or the trunks of the trees to be comminuted.
